(19) United States
(12) Patent Application Publication
(10) Pub. No.: US 2005/0077370 A1
(43) Pub. Date: Apr. 14, 2005

(54) Method for cleaning a surface

(76) Inventors: James D. Decker, Apple Valley, MN (US); Richard J. Mehus, Richfield, MN (US)

Correspondence Address: IPLM GROUP, P.A., POST OFFICE BOX 18455, MINNEAPOLIS, MN, 55418, US

(21) Appl. No.: 10/982,286

(22) Filed: Nov. 4, 2004

Related U.S. Application Data
(62) Division of application No. 10/074,594, filed on Feb. 12, 2002.
(60) Provisional application No. 60/270,673, filed on Feb. 22, 2001.

(51) Int. Cl. B05D 1/00; B67B 7/00; G01F 11/00; B05B 17/00

(52) U.S. Cl. 239/1; 239/569; 239/398

(57) ABSTRACT

The present invention relates to a method for cleaning a surface by connecting a cleaning system to a faucet, which contains water from a water source. The cleaning system includes a hose member and a dispensing gun, and the hose member interconnects the faucet and the dispensing gun. The faucet is turned on so that water flows from the faucet, through the hose member, and into an inlet of the dispensing gun. A use solution is created within the dispensing gun. The use solution is then sprayed from the dispensing gun onto the surface. The faucet is turned off, and water is allowed to discharge from the hose member and the dispensing gun. The hose member is disconnected from the faucet.

This application is a divisional of U.S. patent application Ser. No. 10/074,594, filed Feb. 12, 2002, which claims the benefit of U.S. Provisional Application Ser. No. 60/270,673, filed Feb. 22, 2001, which are hereby incorporated by reference herein.

### FIELD OF THE INVENTION

The present invention relates to a method for cleaning a surface, and more particularly, the present invention relates to connecting a dispensing and rinsing gun to a faucet.

### BACKGROUND OF THE INVENTION

Dispensing and rinsing guns are commonly used in the cleaning industry, and are used for washing, rinsing, and sanitizing items such as bathroom fixtures, floors, walls, and counter tops. These guns may also be used for various other types of cleaning including laundry and automobile care.

Most dispensing and rinsing guns require the product to be switched on and off at a remote station, and they require that the liquid diluent/liquid concentrate solution run through an outlet hose. Previous wall mounted or remote mounted devices require a time delay to purge the first product out when switching to the second product to ensure there is no contamination of the outlet hose with the other product. With these devices, additional outlet hoses could be attached to the units in order to provide greater mobility of the devices. However, with the longer outlet hoses, the back pressure of the devices is increased and this reduces or eliminates the dispensing ability. Also, some previous devices do not provide a rinse mode for a water only dispensing mode and may require electricity to trigger an electric pump at the water and product reservoir.

Previous devices that use a single dispensing hose require the attachment of one of two or three different dispensing nozzles for using different products. These nozzles provide fan spray and foaming action, and they also provide a method of regulating the flow during the rinsing operation. With these devices, it is possible to lose the nozzles or utilize the wrong nozzle for the particular product.

The present invention allows water and product to be dispensed from one gun without purging the outlet hose before using different dispensing modes of the gun and without electricity. The gun may be turned on and off from the gun itself rather than at a remote location, and the gun uses water from an ordinary faucet to dilute and dispense the product.

### SUMMARY OF THE INVENTION

In a preferred embodiment method for cleaning a surface, a cleaning system is connected to a faucet, which contains water from a water source. The cleaning system includes a hose member and a dispensing gun, and the hose member interconnects the faucet and the dispensing gun. The dispensing gun contains an inlet, an outlet, and an aspirator. The aspirator has a water inlet, a product inlet, and a use solution outlet. The faucet is turned on so that water flows from the faucet, through the hose member and into the inlet of said dispensing gun. A first valve in said dispensing gun is activated, and the first valve allows water to flow from the inlet into the water inlet of the aspirator where it mixes with a product from the product inlet and is released from the use solution outlet as a use solution. The use solution is then sprayed from the use solution outlet onto a surface. The faucet is then turned off, and water is allowed to discharge from the hose member and the dispensing gun. The hose member is disconnected from the faucet.

In a preferred embodiment method for cleaning a surface, a cleaning system is connected to a faucet, and the cleaning system includes a hose member and a dispensing gun. The hose member interconnects the faucet and the dispensing gun. The dispensing gun contains an inlet and an outlet, and the faucet contains water from a water source. The faucet is turned on so that water flows from the faucet, through the hose member, and into the inlet of the dispensing gun. A first valve is activated in the dispensing gun, and the first valve allows water to flow from the inlet where it mixes with a product to create a use solution. The use solution is sprayed from the outlet onto a surface. A second valve is activated in the dispensing gun, and the second valve allows water to flow from the inlet to the outlet. Then, water is sprayed from the outlet onto the surface to rinse the use solution from the surface.

### BRIEF DESCRIPTION OF THE DRAWINGS

FIG. 1 shows a quick disconnect assembly interconnecting a dispensing and rinsing gun, a product caddy, and a faucet;

FIG. 2 shows a quick disconnect assembly interconnecting a dispensing and rinsing gun with product pouches attached thereto and a faucet;

FIG. 3 is a cross sectional view of a quick disconnect with back flow prevention in a closed position used in the quick disconnect assembly shown in FIGS. 1 and 2;

FIG. 4 is a cross sectional view of the quick disconnect of FIG. 3 in an open position;

FIG. 5 is a top view of a metal disc and a stem of the quick disconnect shown in FIGS. 3 and 4;

FIG. 6 is a cross sectional view of a faucet aerator assembly with outer threads that connects to the faucet shown in FIG. 1;

FIG. 7 is a cross sectional view of a faucet aerator assembly with inner threads that connects to the faucet shown in FIG. 1;

FIG. 8 is an exploded assembly view of the product caddy shown in FIG. 1;

FIG. 9 is an exploded cross sectional assembly view of a product selector valve of the product caddy shown in FIG. 8;

FIG. 10 is an assembled cross sectional view of the product selector valve of FIG. 9;

FIG. 11 is a cross sectional view of a gun for use with the caddy of FIG. 8 in an open position;

FIG. 12 is a cross sectional view of a gun for use with the caddy of FIG. 8 in a closed position;

FIG. 13 is a perspective view of the dispensing and rinsing gun for use with product shown in FIG. 2;

FIG. 14 is a cross sectional view of the dispensing and rinsing gun shown in FIG. 13;

FIG. 15 is an exploded assembly view of the dispensing and rinsing gun shown in FIG. 13; and

FIG. 16 shows the dispensing and rinsing gun of FIG. 13 with product pouches attached thereto.

### DETAILED DESCRIPTION OF THE PREFERRED EMBODIMENT

The present invention relates to a method and apparatus for cleaning a surface, and more particularly, the present invention relates to a quick disconnect assembly interconnecting a dispensing and rinsing gun and a faucet. A preferred embodiment quick disconnect assembly constructed according to the principles of the present invention is designated by the numeral 99, and a preferred embodiment dispensing and rinsing gun constructed according to the principles of the present invention is designated by the numerals 200, 200′, and 300.

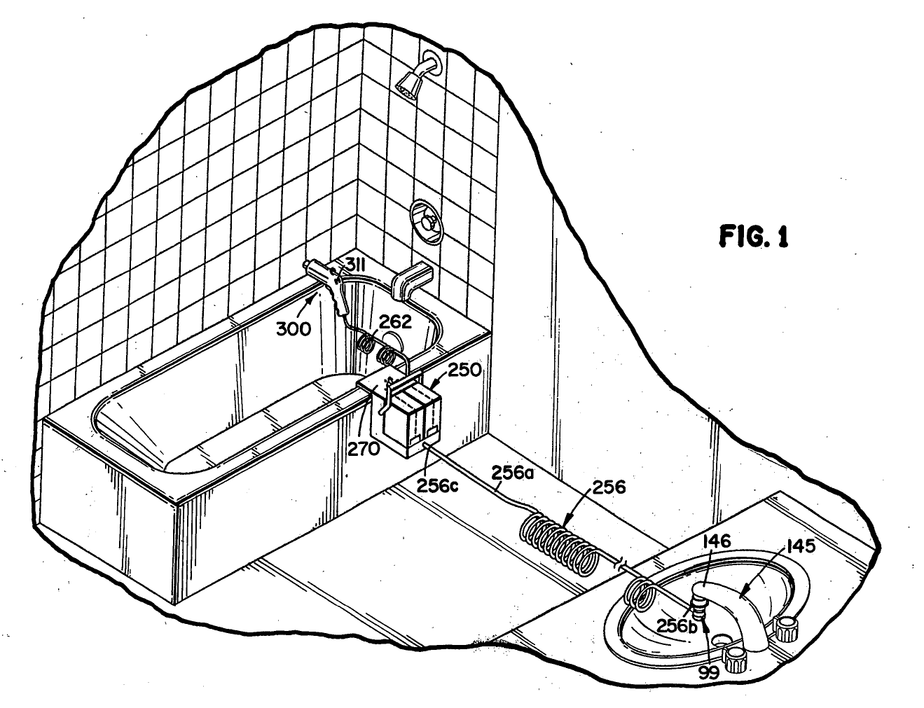

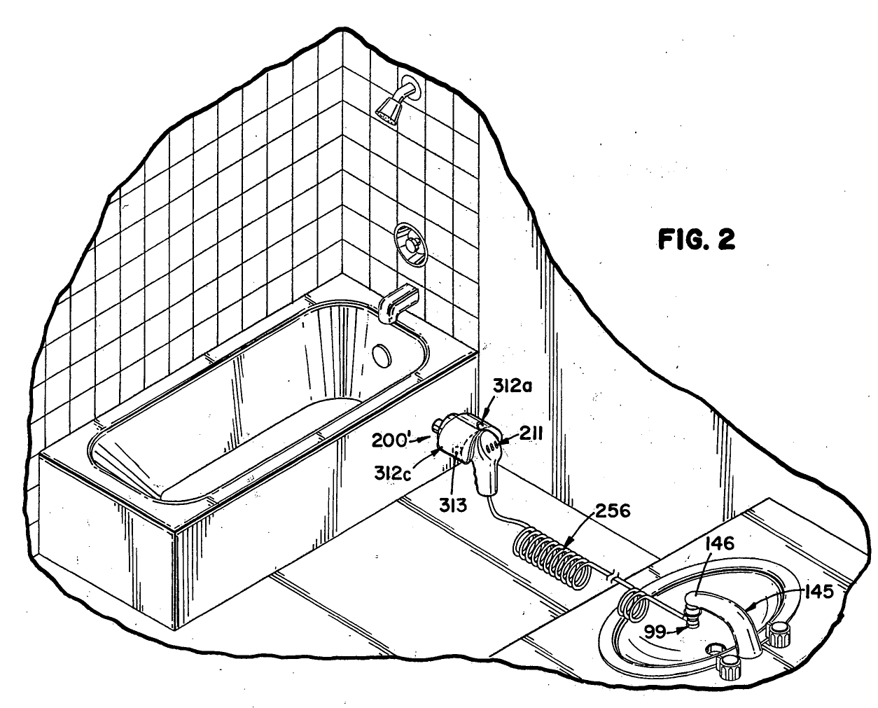

As shown in FIGS. 1 and 2, this portable dilution cleaning system is a device for applying any detergent and/or rinsing product directly onto surfaces being cleaned. The system connects very quickly to a faucet 145 using the quick disconnect assembly 99, and the dispensing and rinsing gun 200, 200′, or 300 sprays use solutions and rinse water directly onto the surface to be cleaned. The quick disconnect assembly 99 includes a quick disconnect with a back flow prevention 100 and a quick disconnect aerator 147. This cleaning system is ideal for cleaning at a low flow with products that must be diluted and applied to large surfaces. The device may be used where there is lower water flow and volume and the local water source is a sink faucet 145 that has a water outlet 146. Possible application areas could be hotel guest bathrooms, public restrooms, hospital/nursing home bathrooms, surgery suites, private home bathrooms, public kitchens, and home kitchens. Consumer use could include bathrooms, restrooms, toilets, kitchens, floors, and carpet. Depending upon the length of the hose, areas that could be cleaned are sinks, showers, baths, floors, toilets, urinals, carpet, walls, equipment, etc. There are potential applications in laundry such as pre-spotting clothing and in vehicle care such as detailing work. Applications are also possible in pest elimination for applying pesticide into small openings and in health care for disinfecting areas. The system could be used where the application is mobile and where the use solution is applied directly onto the surface.

This portable cleaning system includes six main components. The first main component is a quick disconnect aerator assembly 147, which replaces the existing aerator on the water outlet 146 of the sink faucet 145. The quick disconnect aerator assembly 147 is shown in FIGS. 6 and 7. This is an important component of the cleaning system because it allows the quick disconnect feature to be used with an ordinary faucet 145 without requiring any special features on the faucet 145.

In the preferred embodiment, the housing 150 is chrome-plated brass, but other suitable materials may be used for this component. The housing 150 is a hollow cylinder that includes a cavity 156 having an inlet 154 on the top and an outlet 155 on the bottom. The inside portion of the cylindrical housing 150 proximate the inlet 154 includes threads 151 for attachment to the water outlet 146 of the faucet 145 that also has threads. The threads 151 are constructed and arranged to mate with the threads of the water outlet 146 where the original aerator was previously attached. FIG. 6 shows the threads 151 on the outer surface of the housing 150, and FIG. 7 shows the threads 151 on the inner surface of the housing 150. Proximate the termination of the threads 151 on the inside surface of the housing 150 is a rubber washer 152 that seals the mating housing 150 and faucet 145 when connected. An aerator 153 is located below the rubber washer 152 proximate the outlet 155. The aerator 153 is known in the art, and in addition to functioning as an aerator, the aerator 153 allows water lines to be hooked up downstream from the faucet 145. The aerator 153 is typically a screen and is not shown in detail as it is well known in the art. Housing 150 also includes a groove or detent 148 around its outside perimeter proximate the middle of the cylinder. The groove or detent 148 allows quick and easy attachment of the quick disconnect 100, which is discussed below.

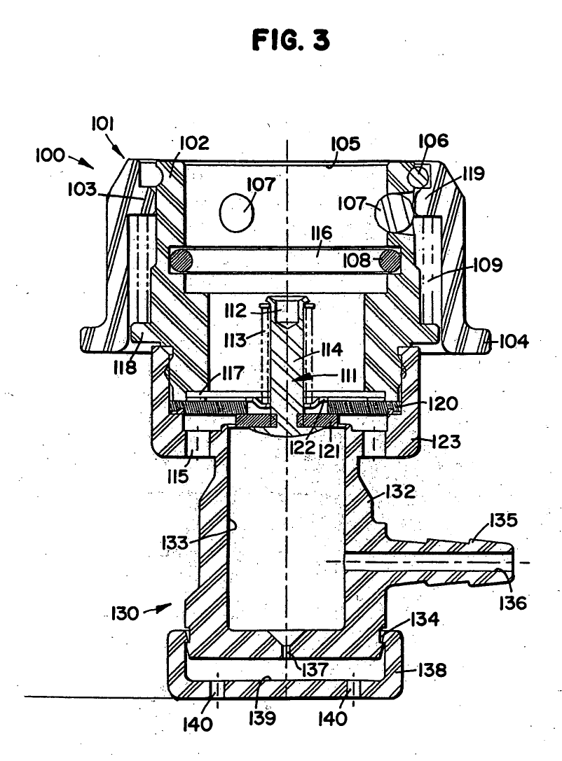

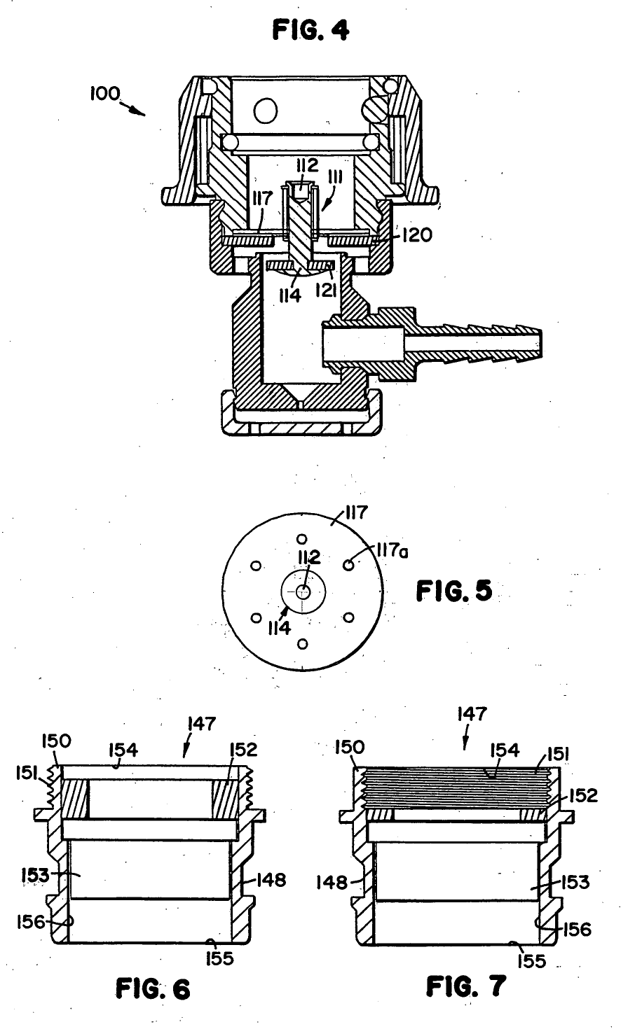

The second main component is a hose quick disconnect with back flow prevention 100 as shown in FIGS. 3 and 4. The quick disconnect with back flow prevention 100 connects the water delivery hose 256 to the faucet 145 by quickly and easily connecting to the quick disconnect aerator 147. In the preferred embodiment, this part is made of plastic, but it may also be made of brass or any other suitable material known in the art. The quick disconnect with back flow prevention 100 includes a top portion 101 and a bottom portion 130.

The top portion 101 includes an inner member 102 and an outer member 103, which are both hollow cylinders, and the outside member 103 is constructed and arranged to fit around the inner member 102. The inner member includes a cavity 105. The outer member 103 has an inside ledge 119 protruding from the top of its inside surface and the inner member 102 has an outside ledge 118 protruding from the bottom of its outside surface. Between the inside ledge 119 and the outside ledge 118 there is a gap in which a spring 109 is placed. The spring 109 pushes the outer member 103 upward by pushing against the inside ledge 119 and the outside ledge 118. A retaining ring 106 is operatively connected to the top portion of the outside circumference of the inner member 102 to keep the outer member 103 from extending beyond the top of the inner member 102.

The inner member 102 also includes a plurality of holes in alignment along its circumference proximate the top portion, and balls 107 are placed therein. The holes have a smaller diameter on the inside surface than the diameter on the outside surface of the inner member 102 so that the balls 107 do not come out of the inner member 102 from the inside but may come out from the outside. In other words, the inside diameter is smaller than the diameter of the balls 107 and the outside diameter is larger than the diameter of the balls 107. However, the outer member 103 holds the balls 107 in place so they do not fall out from the outside surface of the inner member 102. The balls 107 are constructed and arranged on the inner member 102 so that they engage the groove or detent 148 of the quick disconnect aerator assembly 147. Therefore, the quick disconnect aerator assembly 147 acts as a first mating member and the quick disconnect with back flow prevention 100 acts as a second mating member, and the balls 107 act as a movable lock to lock these mating members together. In addition, the inner member 102 includes an indentation 116 in which an O-ring 108 is placed, and the O-ring 108 acts to seal the mating connection between the quick disconnect with back flow prevention 100 and the quick disconnect aerator assembly 147.

When the outer member 103 is pushed upward by the spring 109, the balls 107 are pushed against the inside diameter of the holes in the inner member 102. In this position, the balls 107 are locked in place and therefore lock the quick disconnect with back flow prevention 100 and the quick disconnect aerator assembly 147 together when connected. When the outer member 103 is pulled downward, the balls 107 are released and no longer lock the quick disconnect with back flow prevention 100 and the quick disconnect aerator assembly 147 together. Therefore, the outer member 103 must be pulled downward to both connect and disconnect the quick disconnect assembly 99. The outer member 103 also includes an outside ledge 104 that provides a surface to pull the outer member 103 downward by compressing the spring 109 and thereby provides an easy way to lock and unlock the assembly 99.

The top portion 101 also includes a diaphragm assembly 111 located on the bottom surface of the top portion 101 within the center of the cavity 105. The diaphragm assembly 111 includes a cap 112, a spring 113, a stem 114, a spring stop member 122, a rubber diaphragm 120, and a rubber diaphragm 121. The cap 112 rests upon the spring 113, which surrounds the stem 114 and extends upward from the bottom surface of the top portion 101 into the center of the cavity 105. The stem 114 is operatively connected to the spring stop member 122, which is located between a metal disc 117 and the rubber diaphragm 120 along the bottom surface of the inner member 102. The rubber diaphragm 120 is a thin rubber disc and extends from the sides of the inner member 102 toward the spring 113 but does not contact the spring 113. The rubber diaphragm 121 is also a thin rubber disc and is located between the rubber diaphragm 120 and the bottom of the inner member 102 and is operatively connected to the stem 114 but does not extend to the sides of the inner member 102. A metal disc 117, shown in FIG. 5, having a plurality of holes 117a positioned around the stem 114 is also placed along the bottom surface of the inner member 102 on top of the spring stop member 122. The spring stop member 122 is a thin disc located between the metal disc 117 and the diaphragm 120 and is operatively connected to the stem 117 proximate the end of spring 113. When the stem 114 is in an upright position, as shown in FIG. 3, the rubber diaphragm 121 contacts the rubber diaphragm 120 and prevents water from passing through the holes in the metal disc 117. When water pressure is exerted upon the cap 112, the spring 113 and the stem 114 are compressed and deflect the rubber diaphragm 121 downward to allow water to pass through the metal disc 117 into the bottom portion 130. This is shown in FIG. 4. Also, the diaphragm assembly 111 acts as a check valve for back flow prevention because the diaphragm assembly seals off the holes in the metal disc 117 so water cannot flow back into the top portion 101 once the water has been turned off from the faucet 145. Because the holes are sealed, the water must exit through the vent holes 115 in the bottom portion 130, which are described below. The check valve has a small flow of approximately ⅓ gallon. Although the flow could be up to 1½ gallon, but ⅓ gallon is preferred.

The bottom portion 130 includes a body 132 having a cavity 133, a rim 123, vent holes 115, an indentation 134, a connector 135, and a funnel 137. The rim 123 is located along the top of the bottom portion 130 and is operatively connected to the bottom of the top portion 101. The rim 123 has an opening that allows access to a cylindrical cavity 133, which is in fluid communication with the cavity 105 when the holes of the metal disc 117 are not sealed by the diaphragm 120. The vent holes 115 are located along the bottom of rim 123, which surrounds the top of cavity 133 and is below the diaphragm 120. When the holes of the metal disc 117 are sealed by the diaphragm 120, water may exit the quick disconnect with back flow prevention 100 via the vent holes 115 and not enter the top portion 101. The cavity 133 is also in fluid communication with bore 136, which extends through the connector 135. The connector 135 extends from the body 132 and provides a surface to which a hose 256 may be attached. The funnel 137 is in fluid communication with the cavity 133 and a cavity 139, which is located beneath the body 132. The funnel 137 allows a small amount of water to drip from the quick disconnect with back flow prevention 100 to indicate when water is turned on and running through the assembly 99. The indentation 134 surrounds outside perimeter along the bottom of the bottom portion 130 and provides a surface on which the diffuser cap 138 is attached. The diffuser cap 138 is a clear cover with drip holes 140 and acts as a bumper to slow down the flow of water dripping from the assembly 99 through the drip holes 140. The cavity 139 is defined by the bottom of the bottom portion 130 and the inside surface of the diffuser cap 138.

The third main component is the hose member 256 as shown in FIGS. 1, 2, and 8. The hose member 256 includes a channel 256a through which water is transported from the quick disconnect assembly 99 to either the caddy 250 or the dispensing and rinsing gun 200 or 200′. A first end 256b of hose member 256 connects to the quick disconnect assembly 99 and a second end 256c of hose member 256 connects to either the caddy 250 or the dispensing and rinsing gun 200 or 200′. In the preferred embodiment, the hose member 256 is a coiled, urethane hose that extends and retracts in a range from approximately three feet to fifteen feet long for ease of use and ease of transporting the portable cleaning system. However, any suitable hose member may be used.

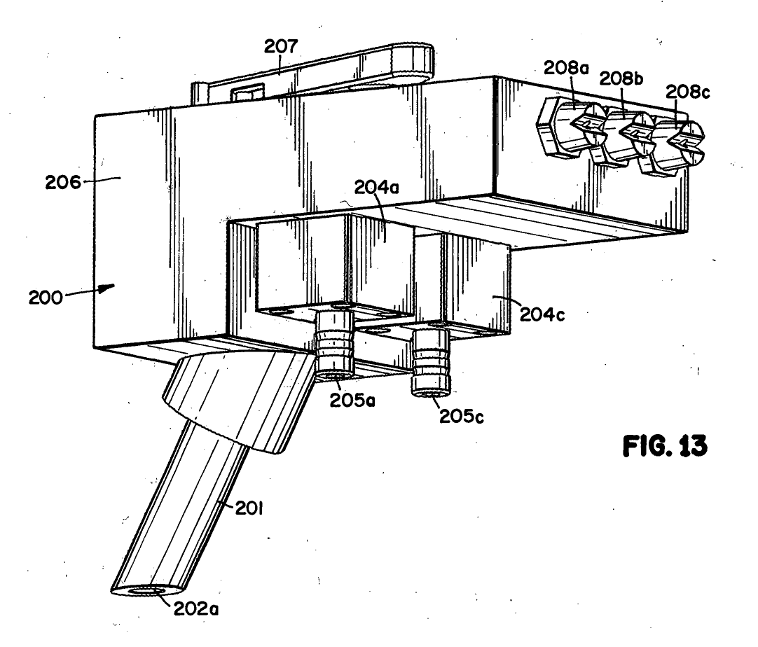

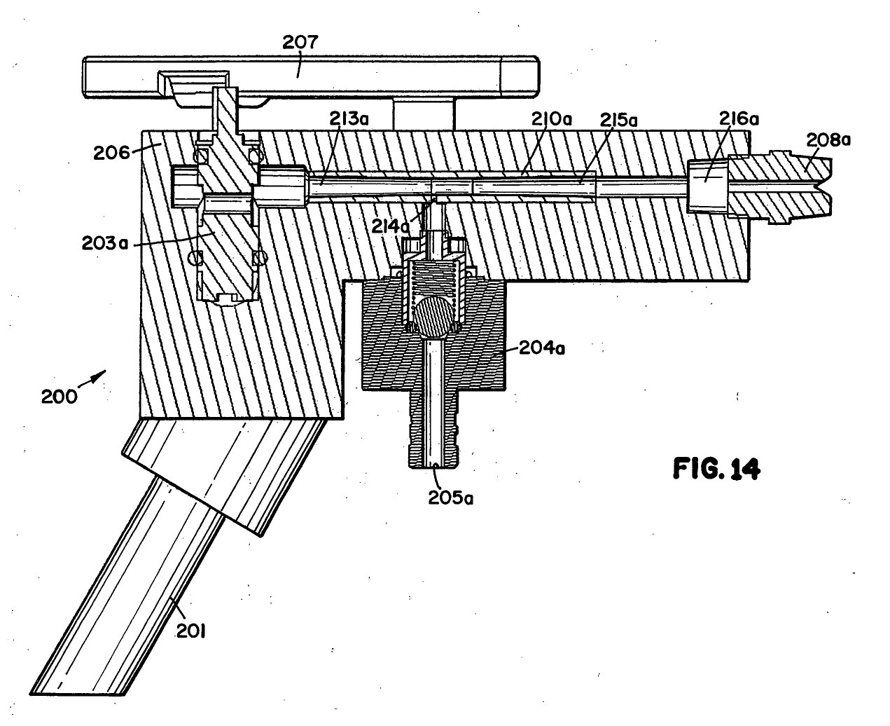

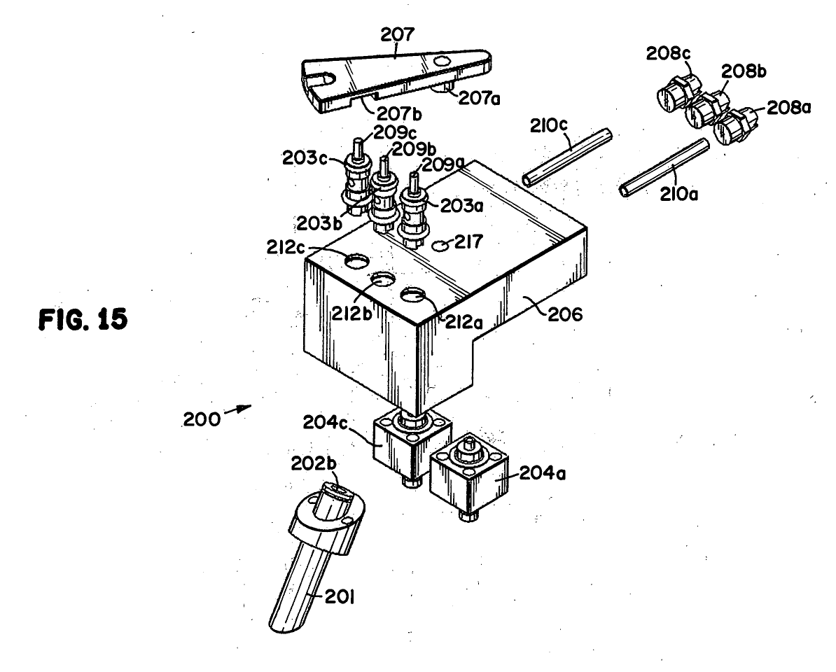

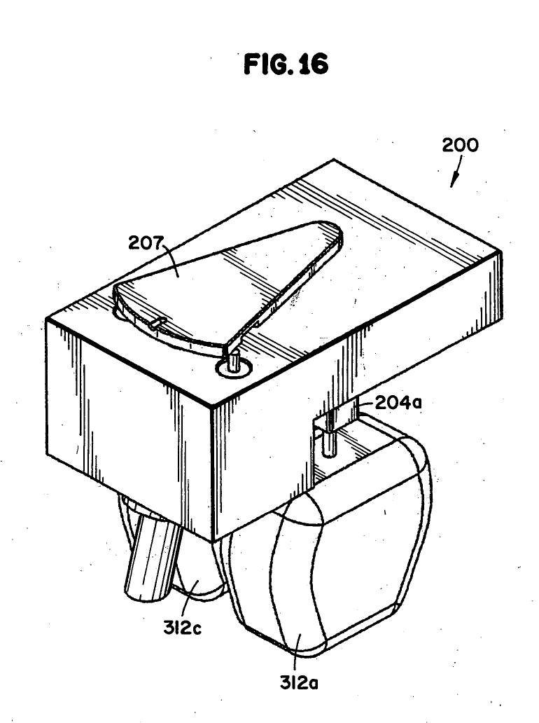

The fourth component is a dispensing and rinsing gun. The dispensing and rinsing gun 200 is shown in detail in FIGS. 13-15. The gun 200 includes housing 206 that is constructed and arranged to accommodate the components of the gun 200 and provides a path for the liquids flowing therethrough. A handle 201 is operatively connected to the bottom of housing 206 and includes an inlet 202a and an outlet 202b. The first end 256b of hose member 256 is operatively connected to the inlet 202a. Water flows from the channel 256a of hose member 256, into the inlet 202a, out of outlet 202b, and into one of three water valves 203a, 203b, and 203c located inside the housing 206 above the handle 201. The housing 206 includes three holes 212a, 212b, and 212c on its top surface opposite the handle 201. The water valves 203a, 203b, and 203c are push button valves known in the art, and each of the push buttons 209a, 209b, and 209c extends through one of the holes 212a, 212b, and 212c, respectively.

The valves 203a, 203b, and 203c are selected by using the valve selector 207 located on the top of the housing 206 proximate the valves 203a, 203b, and 203c. The selector 207 is V-shaped and includes a pin 207a proximate the point of the “V” and a cam 207b proximate the wider part of the “V.” The pin 207a is operatively connected to a hole 217 in the top of housing 206 so that the selector may pivot at this point. The cam 207b is constructed and arranged to engage and activate one of the valves 203a, 203b, and 203c. As the selector 207 pivots, one of the valves 203a, 203b, or 203c may be chosen and when the cam 207b is aligned with the desired valve, the cam 207b presses the push button which opens the valve and allows water to pass through the valve. Optionally, selector buttons 211 as shown in FIG. 2 may be used instead of the valve selector 207. Rather than using the cam 207b to compress the button to open the desired valve, the appropriate selector button 211 is compressed. In the preferred embodiment, the water valves 203a, 203b, and 203c are used to direct the flow of water to one of three possible operating modes. The water may simply be sprayed onto a surface, used to dilute a detergent product, or used to dilute a rinse product, and these valves direct the flow of water to the desired operating mode.

After the water has gone through the desired water valve, the water either flows directly to the outlet or it flows to an aspirator. Aspirators 210a and 210c, which are known in the art, are used in the operating modes that use product. The aspirators 210a and 210c include a water inlet 213a and 213c, a product inlet 214a and 214c, and a use solution outlet 215a and 215c, respectively. Generally, as water enters the water inlet, product is drawn into the product inlet to create a use solution, and the use solution exits the aspirator through the use solution outlet and enters the outlet. When the operating mode not utilizing product is chosen, an aspirator is not used and the water flows directly to the outlet. After the water or use solution reaches the outlet, it flows to its corresponding spray nozzle. Spray nozzles 208a, 208b, and 208c are known in the art and are used to dispense the water or use solution.

To dispense water, water flows from the inlet 202a, into water valve 203b, into the outlet, and then out of spray nozzle 208b, which is in fluid communication with the water valve 203b and the outlet and is located at the end of the gun 200. To dispense a detergent product, water flows from the inlet 202a, into water valve 203a, and into aspirator 210a where product from the product inlet 205a of check valve 204a is diluted with the water to create a use solution. The aspirator 210a is located along the length of the gun 200 and is in fluid communication with the water valve 203a and the check valve 204a. The check valve 204a including the product inlet 205a is located along the bottom of the housing 206 below the aspirator 210a. The use solution is then dispensed through the spray nozzle 208a, which is in fluid communication with the aspirator 210a and the outlet 216a and is located at the end of the gun 200. To dispense a rinse product, water flows from the inlet 202c, into water valve 203c, and into aspirator 210c where product from the product inlet 205c of check valve 204c is diluted with the water to create a use solution. The aspirator 210c is located along the length of the gun 200 and is in fluid communication with the water valve 203c and the check valve 204c. The check valve 204c including the product inlet 205c is located along the bottom of the housing 206 below the aspirator 210c. The use solution is then dispensed through the spray nozzle 208c, which is in fluid communication with the aspirator 210c and the outlet and is located at the end of the gun 200.

FIG. 16 shows product pouches 312a and 312c attached directly to the product inlets 205a and 205c of the gun 200 rather than connecting the product via tubing or a conduit. Another dispensing and rinsing gun 200′ is shown in FIG. 2. Dispensing and rinsing gun 200′ is generally constructed the same as dispensing and rinsing gun 200 because gun 200′ includes aspirators and does not require the use of a caddy 250. The product bags 312a and 312c are also attached directly to the gun 200′ and are operatively connected to the top of the gun 200′. Each aspirator contained in the housing of the gun 200′ has a product bag operatively connected thereto by fitments 313. Fitments 313 are well known in the art to connect products to aspirators. In the preferred embodiment, the flexible product bags 312a and 312c are four-ounce bags that are not refillable and do not require a vent. Using product bags that do not require a vent, which can cause product spillage, is preferred for this hand held dispensing system. The flexible four-ounce polymer product bags include a connector, which in the preferred embodiment is manufactured by IPM. The bags automatically reseal when disconnected from the dispensing and rinsing gun 200′, and selector buttons 211 or a selector 207 as shown on gun 200 may be used to select the operating mode of the gun 200′.

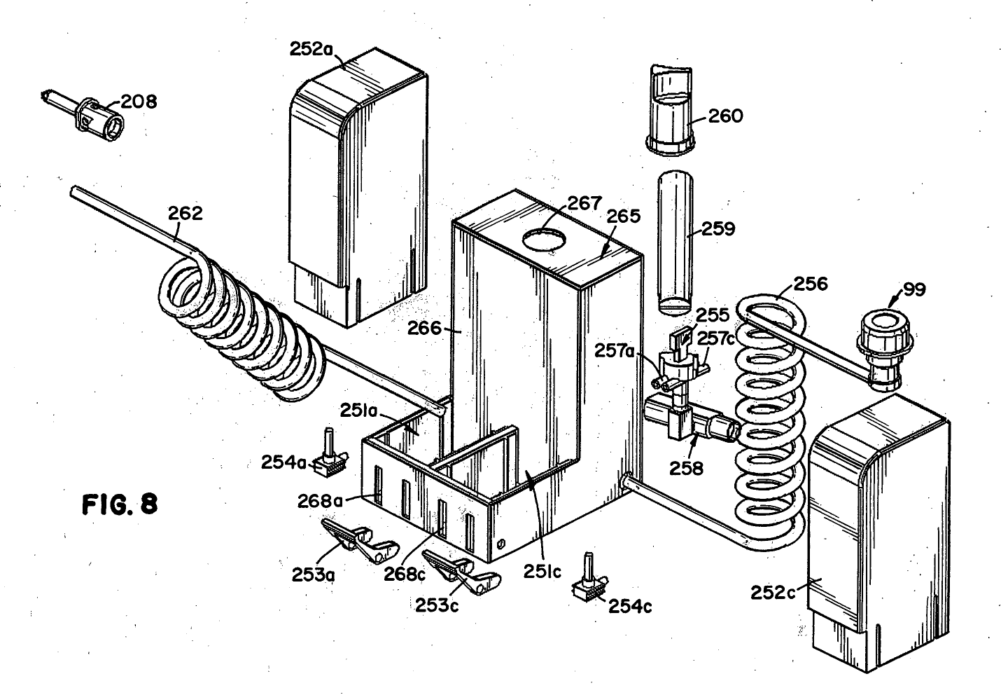

Alternatively, an aspirator 258 may be placed in the caddy 250 containing the product rather than having aspirators 210a and 210c in the guns 200 and 200′. With caddy 250 having an aspirator 258, a conduit 262 is used to dispense the water or use solution through a gun 300 as shown in FIGS. 1 and 8. Therefore, aspirators are required in either the gun 200 or 200′ or in the caddy 250. In the preferred embodiment, a low flow aspirator is used to provide a convenient flow rate for cleaning when used in combination with the dispensing and rinsing gun. The low flow aspirator 1 GPM or less and preferably between ¼ to ½ GPM, and a typical aspirator is 4 GPM. The aspirator is used with a thick product to ensure that a lower concentration of product is used and that the product will last longer. Therefore, the thick product controls the aspiration. When no aspirator is attached directly to the gun, the gun will generally provide approximately a 1 GPM water rinse. An example of such a thick product is a toilet bowl cleaner.

The gun 300 shown in detail in FIGS. 11 and 12 has two positions. The open position is shown in FIG. 11 while the closed position is shown in FIG. 12. The trigger 301 is operatively connected to and controls a valve 302 having a bore 303. When the trigger 301 is in the default position, the bore 303 does not align with the passageway 304 of the gun 300. Therefore, when either water or use solution enters the gun 300 through the conduit 262, neither one is able to flow into the passageway 304 to the nozzle 305 to be dispensed from the gun 300. However, when the trigger 301 is compressed, the valve 302 is rotated so that the bore 303 aligns with the passageway 304 thereby allowing either water or use solution to flow into the passageway 304 and out of the nozzle 305.

The fifth main component is a thick product that allows normal metering tips to be used, and the thick product is more concentrated than normal products. In the preferred embodiment, thick products are desirable because the aspirator operates at low water flow of around ¼ to ½ GPM to dispense the appropriate concentration of product. As the water flow goes down, the aspirator will pull excessively high product concentrations and using thicker products will ensure that the desired amount of product is used in an appropriate concentration. In other words, because the preferred embodiment utilizes a low flow of water, using a thicker product ensures that lower concentrations of product can be used with low flow rates without requiring very small orifice metering tips. The thick product aspirates at a lower level than water, and the range for viscosity is between approximately 200 and 2,000 cps. An advantage to using a thick product in this manner with normal metering tips is that there is a single dilution step with a competitor lock-out. Another advantage to using a thick product is that some thickened acid containing cleaners do not mist as much as unthickened cleaners and the use solution can be sprayed onto surfaces rather than being foamed onto surfaces.

In addition to using thickened products, it is also possible to use cleaning chemicals in a solid form or to even use liquid products without using an aspirator to proportion the products. With solid products, it is possible to proportion the product by either spraying water onto the surface of the solid or running water through a conduit containing the solid. To spray the water onto the surface of the solid thereby creating a use solution, the solid could be contained in a chamber, which includes a sprayer to spray water onto the product and an outlet to dispense the use solution from the chamber. Alternatively, a solid cartridge of product could be placed within a conduit and as water passes through the conduit a use solution is created because the water dissolves part of the product. A liquid product may also be proportioned without using an aspirator. The liquid product may be placed in a chamber including an inlet and an outlet. Water is diverted into the inlet where it creates a use solution with the liquid product contained therein, and the use solution flows out of the chamber outlet. Presently, there are two ways in which this can be done commercially. The liquid could be proportioned and dispensed by a diaphragm or water could simply dilute the product, which will become more dilute over time. Therefore, it is understood that product may be dispensed with or without an aspirator in the present invention.

The final main component is a caddy 250 as shown in FIG. 8, which is used to tote the products used with the dispensing and rinsing gun 300. The caddy 250 includes a housing 265 having product holders 251a and 251c and product bag housings 252a and 252c. The product holders 251a and 251c are rectangular bins in the housing 265 where the product bags (not shown) are placed. The product bag housings 252a and 252c house the product bags and are constructed and arranged to fit over the product bags and cover the product holders 251a and 251c. Proximate the edge of the product holders 251a and 251c are slots 268a and 268c through which U-shaped product bag housing removers 253a and 253c are placed to remove the housings 252a and 252c, respectively, when the products must be changed. The removers 253a and 253c are placed through the slots 268a and 268c and push the housings 252a and 252c upward thereby allowing them to be removed from the holders 251a and 251c.

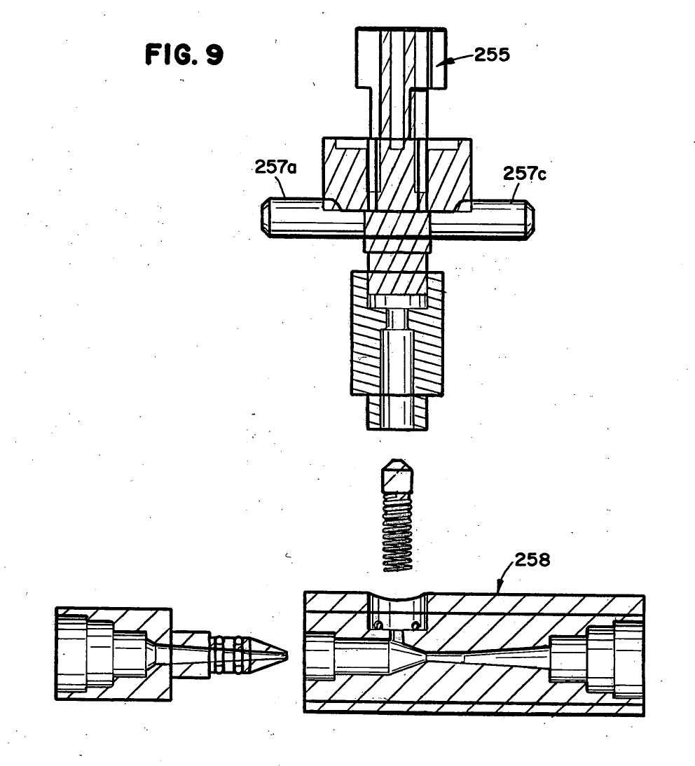

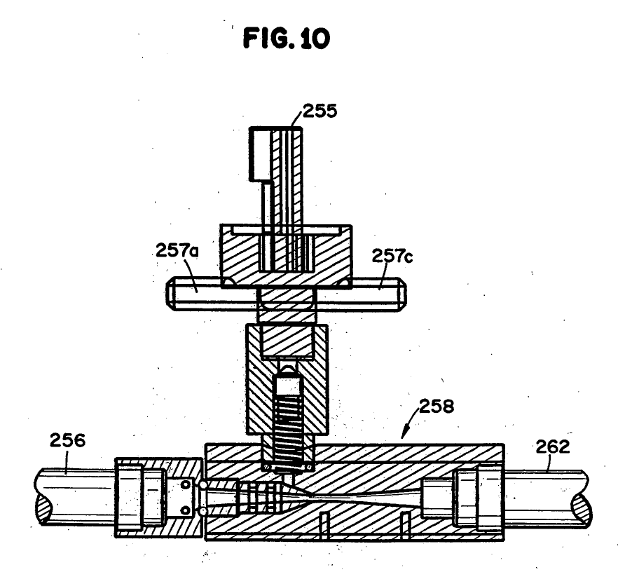

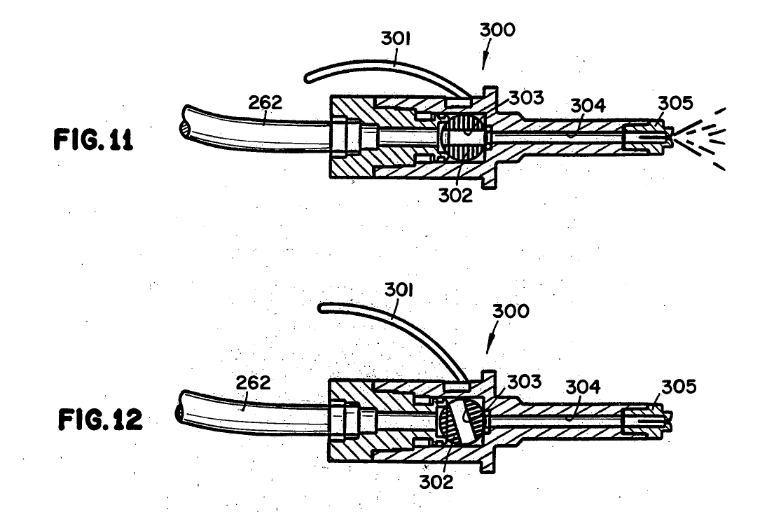

The housing 265 also includes a box 266 that contains several components. Product inlet connectors 254a and 254c are placed inside the box 266 proximate the holders 251a and 251c and interconnect the product bags and the product inlets 257a and 257c, which are in fluid communication with the aspirator 258. The product bags include hoses (also not shown) that extend from the bags and connect to the product inlet connectors 254a and 254c, which allow the products to flow through the product inlet connectors 254a and 254c into the product inlets 257a and 257c. The aspirator 258 is connected to the product selector valve 255, which is controlled by the product selector extender 259 and the product selector handle 260. The product selector handle 260 extends through the opening 267 on the top of the box 266 and the product selector extender 259 interconnects the handle 260 to the valve 255. FIGS. 9 and 10 show how the product selector valve 255 cooperates with the aspirator 258 to dispense the use solution. The water inlet tube or hose 256 extends from the quick disconnect assembly 99 through the side of the box 266 and is operatively connected to the aspirator 258, and a conduit 262 is also operatively connected to the aspirator to carry water or use solution to the gun 300. In addition, the housing 265 may include an arm 270, which is shown in FIG. 1, that extends from the top of the box 266 outward to hook onto a surface such as a bathtub ledge or other surface.

In operation, after the quick disconnect assembly 99 has been connected to the faucet 145, the faucet 145 is turned on and water flows out of the water outlet 146 into the quick disconnect assembly 99. The pressure from the water pushes the cap 112 downward thereby ultimately deflecting the diaphragms 120 and 121 away from the metal disc 117 and allowing water to pass through the assembly 99. Then the water travels through the hose 256 into either the aspirator in the caddy 250 or in the guns 200 or 200′ to create a use solution with the selected product. Alternatively, the water is dispensed through the gun 200, 200′, or 300 without creating a use solution depending upon the selected operating mode as described previously.

After the cleaning system has been used, the water is turned off and pressure is no longer exerted upon the cap 112. Therefore, the diaphragm assembly 111 acts as a check valve within the quick disconnect with back flow prevention 100 to prevent water from entering the faucet 145 because the rubber diaphragm 120 blocks the holes in the metal disc 117. The quick disconnect with back flow prevention 100 may be disconnected from the quick disconnect aerator 147 by pulling down on the outside ledge 104 to release the balls 107 from the groove or detent 148 and may be connected to another quick disconnect aerator 147 in another location.

Advantages to using this cleaning system include that it only takes 4 to 5 seconds to switch from one product to another by simply changing the position of the valve selector. Also, there are no batteries to recharge, and there are no pumps or motors and therefore less maintenance is required. The batteries and pumps have been replaced with a direct and a simple connection to a sink. In addition, the dispensing and rinsing gun has a low weight and a small size and is therefore easy to handle and transport. The weight is approximately two pounds and ¼ cubic foot without the caddy and approximately three pounds and one cubic foot with the caddy. These are just a few advantages and there are numerous other advantages to using this cleaning system.

There are also many advantages to using this system over using spray bottles. For example, there is no need to go to a central supply area to refill the product, there is no fatigue from using the lever on the spray bottles, there is complete detergent coverage on the area being cleaned, and there is the ability to rinse the area being cleaned. Also, a rinse aid may be used with the dispensing gun to facilitate drying, it is faster and more efficient to use the dispensing gun, and the products are contained in small disposable packaging. In addition, the system is easy to use with minimal training, the system has a professional image, and the system can accommodate various products for use in a variety of different areas for different types of cleaning.

The above specification, examples and data provide a complete description of the manufacture and use of the composition of the invention. Since many embodiments of the invention can be made without departing from the spirit and scope of the invention, the invention resides in the claims hereinafter appended.

1. A method for cleaning a surface, comprising the steps of:
connecting a cleaning system to a faucet, said cleaning system including a hose member and a dispensing gun, said hose member interconnecting said faucet and said dispensing gun, said dispensing gun containing an inlet, an outlet, and an aspirator, said aspirator having a water inlet, a product inlet, and a use solution outlet, and said faucet containing water from a water source;
turning on said faucet so that water flows from said faucet, through said hose member and into said inlet of said dispensing gun;
activating a first valve in said dispensing gun, said first valve allowing water to flow from said inlet into said water inlet of said aspirator where it mixes with a product from said product inlet and is released from said use solution outlet as a use solution;
spraying said use solution from said use solution outlet onto a surface;
turning off said faucet;
allowing said water to discharge from said hose member and said dispensing gun; and
disconnecting said hose member from said faucet.

2. The method of claim 1, further comprising the steps of:
before said faucet is turned off activating a second valve in said dispensing gun, said second valve allowing water to flow from said inlet to said outlet, and spraying water from said outlet onto said surface to rinse said use solution from said surface.

3. A method for cleaning a surface, comprising the steps of:
connecting a cleaning system to a faucet, said cleaning system including a hose member and a dispensing gun, said hose member interconnecting said faucet and said dispensing gun, said dispensing gun containing an inlet and an outlet, said faucet containing water from a water source;
turning on said faucet so that water flows from said faucet, through said hose member and into said inlet of said dispensing gun;
activating a first valve in said dispensing gun, said first valve allowing water to flow from said inlet where it mixes with a product to create a use solution;
spraying said use solution from said outlet onto a surface;
activating a second valve in said dispensing gun, said second valve allowing water to flow from said inlet to said outlet; and
spraying water from said outlet onto said surface to rinse said use solution from said surface.

4. The method of claim 3, said first valve being in fluid communication with an aspirator, said aspirator having a water inlet, a product inlet, and a use solution outlet, said first valve allowing water to flow from said inlet into said water inlet where it mixes with a product from said product inlet and is released from said use solution outlet as a use solution.
